(19) United States
(12) Patent Application Publication
(10) Pub. No.: US 2007/0195791 A1
(43) Pub. Date: Aug. 23, 2007

(54) Route optimization for proxy mobile internet protocol

(76) Inventors: Peter Bosch, New Providence, NJ (US); Peter McCann, Naperville, IL (US); Girija Narlikar, Baskinridge, NJ (US); Paul Anthony Polakos, Marlboro, NJ (US); Louis Gwyn Samuel, Swindon (GB)

Correspondence Address: WILLIAMS, MORGAN & AMERSON, 10333 RICHMOND, SUITE 1100, HOUSTON, TX, 77042, US

(21) Appl. No.: 11/356,735

(22) Filed: Feb. 17, 2006

(51) Int. Cl. H04L 12/56

(52) U.S. Cl. 370/395.52

(57) ABSTRACT

The present invention provides a method of route optimization for a proxy mobile Internet protocol. The method may include providing information indicative of a first proxy address based on a first address associated with a first access terminal and receiving information indicative of a second proxy address associated with a second access terminal. The method may also include establishing a communication link between the first access terminal and the second access terminal based on the first and second proxy addresses such that the communication link does not include a home agent.

### BACKGROUND OF THE INVENTION

1. Field of the Invention

This invention relates generally to communication systems, and, more particularly, to wireless communication systems.

2. Description of the Related Art

In conventional wireless telecommunications, one or more access terminals may establish a mobile communication path through a wireless link to a Radio Access Network (RAN). Typically such paths employ the Internet Protocol (IP) as a communication mechanism. The RANs are generally hierarchically organized so that one or more network elements may operate in concert to bridge Internet Protocol (IP) packets from a wired network to access terminals in the wireless communication network. In such a network of elements, each network element implements a portion of the wireless protocol stack. In conventional networks, Internet Protocol (IP) communication is established deep in the wireless core network by a network element called a Packet Data Switched Node (PDSN) or a Gateway General Packet Radio Service (GPRS) Support Node (GGSN). Depending on the architecture, the communication path between the PDSN/GGSN and the access terminal may be specific to the wireless air standard and typically not based on the well-established IP communication mechanisms.

An alternative to the conventional hierarchical network architecture is a distributed architecture including a network of integrated RANs. In an integrated RAN, a base station implements the base station function (BTS), the base station controller function (BSC) and the network element functions required to route and control IP packets between wireless access terminals and wired IP networks. The integrated RAN is typically referred to as a Base Station Router (BSR). For example, each BSR may combine RNC and/or PDSN functions, and potentially higher nodes, in a single entity that manages radio links between one or more access terminals and an outside network, such as the Internet. In another embodiment, a BSR may implement a Universal Mobile Telecommunication Service (UMTS) Node B, an RNC, a SGSN and a Gateway GPRS Support Node (GGSN) in a single box. Alternatively, a BSR may implement an IEEE 802.16e RAN in a single network element. Compared to hierarchical networks, distributed architectures have the potential to reduce the cost and/or complexity of deploying the wireless network, as well as the cost and/or complexity of adding additional wireless access points, e.g. BSRs, to expand the coverage of an existing network.

A BSR typically employs Mobile IP technology for establishing and maintaining IP communication for nomadic users. Each access terminal registers with a home agent (HA) and is assigned a home address (HoA). The home agent provides a permanent/semi-permanent attachment to an IP network and so packets addressed to the home address are directed to the home agent. If the nomadic access terminal has roamed away from its own network, the home agent may forwards the packets to the access terminal by way of an IP tunnel. In Mobile IPv4, the access terminal may attach to a foreign network via a foreign agent and obtain a care-of address (CoA) from the foreign network. The foreign agents are typically a part of the PDSN protocol suite and are responsible for providing connectivity between the access terminal and the home agent. For example, the foreign agents may provide point of attachment (PoA) and/or care of address (CoA) functionality for the access terminal.

The care-of address allows the access terminal to communicate on a foreign network. To obtain the packets that are addressed to the HoA address, the home agent and foreign agent maintain an IP tunnel, e.g., using IP security (IP-SEC), generic routing encapsulation (GRE), and/or an IP-in-IP tunnel between the CoA and the access terminal's home agent. Once the tunnel has been established, packets addressed to the HoA may be retrieved from the network by the home agent and tunneled to the CoA of the access terminal via the foreign agent. To transmit packets on the home network while the access terminal is attached to a foreign network, the access terminal encapsulates the IP packet in a tunnel (e.g., using IP-SEC, GRE, IP-in-IP, and/or GPRS Tunneling Protocol, GTP) and transmits the packet to the home agent via the foreign agent. On reception, the home agent de-tunnels the original IP packet and forwards the IP packet on its local IP network for further delivery.

However, the path from the access terminal to the home agent and on to the packet destination may not be the optimal path. For example, when an access terminal on a foreign network is communicating with an IP server on the same foreign network, transmitting the IP packets to the home agent in the home network may not be the most direct path because the packets received by the home agent may need to travel back to the foreign network for final delivery. Instead, an access terminal that is attached to a foreign network may be addressed directly by its CoA so that packets may be sent directly to the access terminal without passing through the home agent.

The process of determining whether to transmit packets via the home agent or directly to an access terminal that may be coupled to a foreign network is typically referred to as route optimization. For example, the Mobile Internet Protocol, version 6 (MIPv6) provides a mechanism for finding optimal delivery paths for packets called mobile IPv6 route optimization. The conventional route optimization technique may determine a direct route between two access terminals (e.g., two mobile IPv6 endpoints) in a two separate steps. First, one of the access terminals, which may be referred to as the mobile node, initiates a return routability procedure to determine if there is a direct path between the endpoints. Second, a binding procedure informs the second access terminal, which is referred to as the correspondent node, to use a direct address of the mobile node.

Once a direct route between CoAs has been established, IP packet transmissions use the CoA addresses to communicate between the endpoints, i.e. the two access terminals. For example, when mobile IPv6 is used in a cellular environment, the CoA is based on the local prefix of the IP anchor, e.g., the CoA address in an Evolution, Data Optimized (EvDO) system would reflect the IP address of the PDSN and the CoA in a Universal Mobile Telecommunication System (UMTS) would reflect the address of the RNC. Accordingly, once routability has been established between endpoints, packets destined for the access terminals can be routed directly through the PDSN or RNC while bypassing the HA or GGSN/SGSN, respectively.

As discussed above, BSRs integrate the functionality of a radio access network (RAN) in a single network element. Thus, in EvDO systems the BSR may implement a BTS, an RNC, and a PDSN. In UMTS, the BSR implements a Node B, a RNC, a SGSN and a GGSN. When the BSR is used in combination with route optimization, the CoA assigned to the access terminal relates to the local prefix of the corresponding BSR. For example, a CoA of the access terminal can be constructed by concatenating the BSR's local prefix in the access terminal's MAC address. Consequently, the CoA may reveal the location of the IP anchor point. For example, the location of the called party may be determined by constructing a database with local prefix and physical locations (e.g., street/city names, GPS coordinates, etc . . . ) associated with BSRs throughout a geographical area. This phenomenon may be less of an issue for existing 3G networks, as the PDSN or RNC typically covers a large geographic area.

Calling parties may use the CoA to determine the physical location of other access terminals and/or the users of the access terminals. For example, if a correspondent node is in communication with a mobile node, e.g., using a Voice over Internet Protocol (VoIP) application or regular TCP/UDP traffic, the correspondent node is made aware of the CoA of the mobile node through the route optimization procedure. If the calling party at the correspondent node has access to a location database of BSRs, PDSNs or RNCs, then the location of the mobile node (or the user thereof) may be determined based on the CoA. Revealing location information of IP anchor points violates user privacy and enables mining of the radio access network layout of a wireless provider. The resolution of the location that may be determined for current PDSNs and RNCs is coarse grained, but the location information that can be revealed by determining the location of a BSR can be precise due to the relatively smaller coverage area of a BSR.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for route optimization for a proxy mobile Internet protocol. The method may include providing information indicative of a first proxy address based on a first address associated with a first access terminal and receiving information indicative of a second proxy address associated with a second access terminal. The method may also include establishing a communication link between the first access terminal and the second access terminal based on the first and second proxy addresses such that the communication link does not include a home agent.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention; and

FIG. 2 conceptually illustrates one exemplary embodiment of a method of route optimization, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

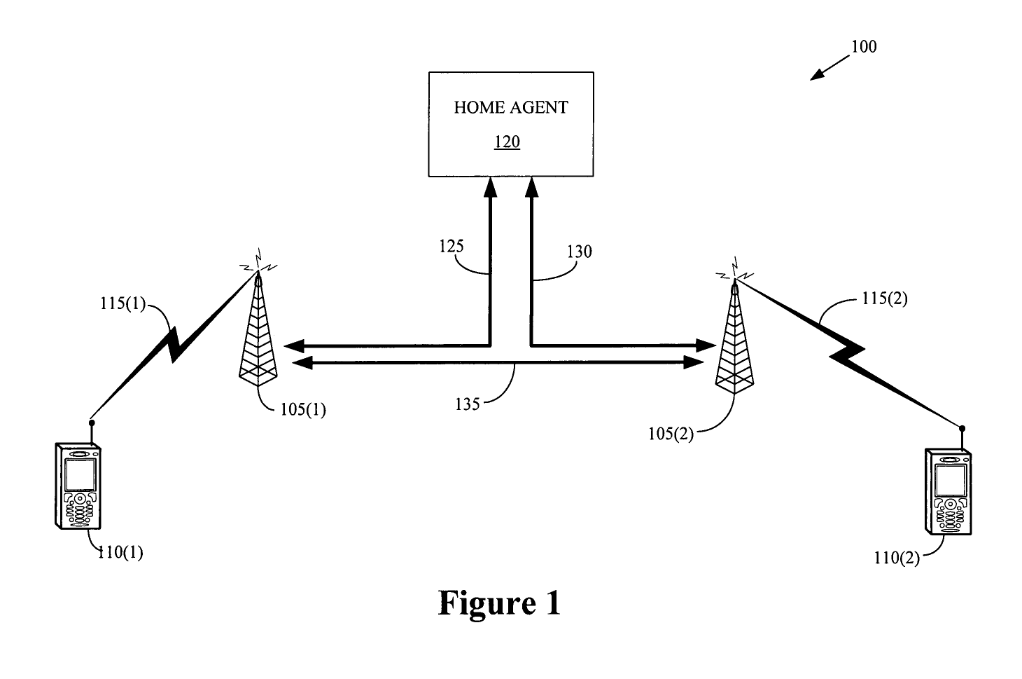

FIG. 1 conceptually illustrates one exemplary embodiment of a wireless communications system 100. In the illustrated embodiment, the wireless communications system 100 may provide wireless connectivity according to third generation wireless communication protocols. Examples of wireless communications systems 100 that operate according to third generation wireless protocols include, but are not limited to Evolution, Data Optimized (EvDO) systems and a Universal Mobile Telecommunication Systems (UMTS). However, persons of ordinary skill in the art should appreciate that the present invention is not limited to a wireless communications system 100 that operates according to EvDO and/or UMTS. In alternative embodiment, any wireless communication protocol may be used to provide wireless connectivity. Furthermore, the present invention is not limited to wireless communications systems. Embodiments of the present invention may also be implemented in wireline communication systems.

The wireless communications system 100 shown in FIG. 1 may include one or more BSRs 105(1-2). In the interest of clarity, the indices (1-2) will hereinafter be dropped when the BSRs 105 are being referred to collectively. However, the indices (1-2) may be used when referring to the BSRs 105 individually or to a subset of the BSRs 105. The same convention will be used with regard to other indices that distinguish between components that share an identifying numeral. Although two BSRs 105 are shown in FIG. 1, persons of ordinary skill in the art should appreciate that the present invention is not limited to wireless communication systems 100 including only two BSRs 105. In alternative embodiments, any number of BSRs 105 may be deployed in the wireless communication system 100.

The BSRs 105 may provide wireless connectivity to one or more access terminals 110. The access terminals 110 shown in the illustrated embodiment have established communication links with respective BSRs 105 over air interfaces 115. Techniques for configuring, initiating, maintaining and/or terminating the air interfaces 115 are known to persons of ordinary skill in the art and in the interest of clarity only those aspects of configuring, initiating, maintaining, or terminating the air interfaces 115 that are relevant to the present invention will be discussed further herein. Moreover, in the interest of clarity, only two access terminals 110 are depicted in FIG. 1. However, persons of ordinary skill in the art having benefit of the present disclosure should appreciate that the present invention is not limited to two access terminals 110 and in alternative embodiments any number of access terminals 110 may be deployed in the wireless communication system 100.

The access terminals 110 may be any type of access terminal including, but not limited to, cellular telephones, personal data assistants, and laptop computers. However, persons of ordinary skill in the art having benefit of the present disclosure should appreciate that the present invention is not limited to these particular examples of access terminals 110 and in alternative embodiments other types of access terminals 110 may also be used. Persons of ordinary skill in the art should also appreciate that the access terminals 110 may be referred to using other terms such as mobile unit, mobile shell, user equipment, user terminal, mobile terminal, subscriber station, subscriber terminal, and the like.

The access terminals 110 register with a home agent 120, which assigns an address to each of the access terminals 110. In one embodiment, the assigned address is an Internet address such as an IPv6 home address (HoA). However, the present invention is not limited to assigning IPv6 home addresses. In alternative embodiments, other Internet addresses, such as IPv4 addresses, may be assigned to one or more of the access terminals 110. Although a single home agent 120 is depicted in FIG. 1, persons of ordinary skill in the art having benefit of the present disclosure should appreciate that the wireless communication system 100 may include more than one home agent 120 and that the access terminals 110 may register with any home agent 120 in the wireless communication system 100. In the illustrated embodiment, the access terminals 110 have both roamed away from their home network(s) and have established a communication link with a BSR 105 over the air interfaces 115. Techniques for configuring and/or operating foreign agents are known to persons of ordinary skill in the art and in the interest of clarity will not be discussed further herein.

The BSRs 105 may associate a proxy address with the address assigned to the attached access terminals 110. As used herein, the term “proxy address” will be understood to refer to an address associated with a BSR 105 that may be used to direct packets intended for an attached access terminal 110 to the BSR 105. When the proxy address is used, the BSR 105 is responsible for handling IP mobility. The access terminal 110 retains its originally assigned address (e.g., the address assigned by the home agent 120) and therefore is unaware of IP mobility when it roams to other networks and BSRs. The proxy address differs from conventional care of addresses because the proxy address is associated with the BSR 105, whereas the conventional care of address is associated with the access terminal 110. Conventional care of addresses may therefore be used to directly address packets to the access terminal 110.

The BSR 105 may translate the proxy address to an address associated with the access terminal 110 and use this address to direct packets to the appropriate access terminal 110. The BSR 105 may also use the proxy address to tunnel packets from the access terminal 110 to the home agent 120. As used herein, the term “tunnel” refers to the headers or other information that may be attached to a message to direct the message to a select a destination, such as the home agent 120. Accordingly, the term “tunneling” will be understood to refer to the process of attaching the headers or other information to the message. In operation, the access terminal 110(1) may provide one or more messages destined for the access terminal 110(2) to the BSR 105(1) over the air interface 115(1). The BSR 105(1) may then wrap the message in a home agent tunnel for delivery to the home agent 120 over the communication link 125. The home agent 120 may then de-tunnel (i.e., remove the tunnel from) the received message. Since both access terminals 110 share the same home agent 120 in the illustrated embodiment, the home agent 120 may tunnel (or re-tunnel) the received message using a proxy address associated with the BSR 105(2). However, persons of ordinary skill in the art should appreciate that in embodiments of the wireless communication system 100 that include additional home agents, the home agent 120 may direct a message to another home agent (not shown), which may tunnel the received message using the proxy address associated with the BSR 105(2).

The appropriately tunneled message may be provided to the BSR 105(2) over the communication link 130. The BSR 105(2) may de-tunnel the received message and translate the proxy address associated with the access terminal 110(2) to the address associated with the access terminal 110(2). The BSR 105(2) may then provide the message to the access terminal 110(2) over the air interface 115(2) using the address associated with the access terminal 110.

The BSR 105(1) may initiate and perform a route optimization process for the access terminals 110. As will be discussed in detail below, the BSR 105(1) may provide a message including the proxy address associated with the access terminal 110(1) to the home agent 120, which may tunnel this message and provide it to the BSR 105(2). The BSR 105(2) may then provide a message including the proxy address associated with the access terminal 110(2) to the home agent 120 in response to the message provided by the BSR 105(1). Including the proxy care-of address in the response is a deviation from the conventional route optimization procedure, e.g., the standard route optimization procedure defined by MoIPv6, and enables the optimized route optimization procedure described in detail below. The BSR 105(1) receives this message from the home agent 120 and may use the proxy addresses associated with the access terminals 110 to establish a communication link 135 between the access terminals 110. The communication link 135 does not include the home agent 120 in the communication pathway.

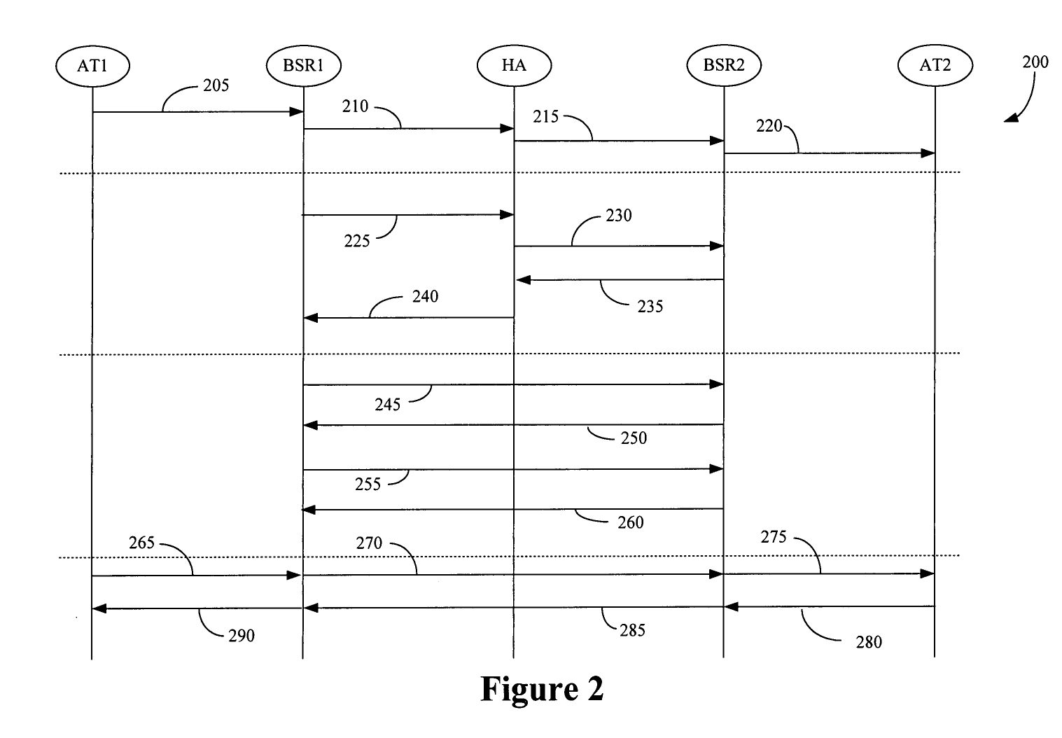

FIG. 2 conceptually illustrates one exemplary embodiment of a method 200 of route optimization. In the illustrated embodiment, the method 200 is implemented in the context of a mobile IPv6 system in which first and second access terminals (AT1, AT2) access a network using first and second BSRs (BSR1, BSR2). The first and second access terminals are registered with a home agent (HA). However, as discussed above, the first and second access terminals do not necessarily have to be registered with the same home agent although they are in the embodiment shown in FIG. 2. The various messages described below will be indicated using a shorthand convention that indicates the source of the message and the destination of the message. In particular, the messages may be written in the form “(Source Device, Destination Device)” or “(Source Device, Destination Device (encapsulated packet))”, when the message encapsulates another packet. The bracketed number pairs appended to the Source Device and Destination Device indicates the source and the IP version, respectively. For example, the notation (M[0,6], M[1,6]) represents a message that is transmitted from the first access terminal to the second access terminal using an IPv6 address.

In the illustrated embodiment, the first and second access terminals communicate by transmitting messages via the home agent. For example, the first access terminal may transmit data by sending a message (M[0,6] M[1,6]) over the wireless link to the first BSR, as indicated by the arrow 205. Since route optimization has not yet been established, the first BSR wraps the message (M[0,6] M[1,6]) in a home agent tunnel for delivery, e.g., the first BSR forms the message (B[0,6] HA (M[0,6] M[1,6])) and provides this message to the home agent as indicated by the arrow 210. Since the second access terminal is served by the same home agent as the first access terminal, the home agent de-tunnels and re-tunnels the original message in a new tunnel for delivery (HA B[1,6] (M[0,6] M[1,6])) and provides this message to the second BSR, as indicated by the arrow 215. The second BSR then de-tunnels the original message and delivers the data over the wireless link by sending (M[0,6] M[1,6]) to the second access terminal, as indicated by the arrow 220.

The first BSR starts the route optimization procedure after it has forwarded the initial data message to the second access terminal. For example, the first BSR may provide a Home Test Initialize (HoTi) message to the home agent (B[0,6] HA (M[0,6] M[1,6] HoTi)), as indicated by the arrow 225. The aim of the HoTi message is to establish a communication path with the target, i.e. the second BSR. This packet is sent through the home agent to enforce sending the message over a secure communication path. Like the data packets, the home agent forwards the message (HA B[1,6] (M[0,6] M[1,6] HoTi)) to the second BSR. Since the mobility procedure is being proxied, the HoTi message is received by the second BSR.

In the illustrated embodiment, a second BSR returns a message including information that indicates a second BSR care of address, as indicated by the arrow 235. For example, the second BSR may include its own CoA in the Home Test (HoT) message (B[1,6] HA (M[1,6] M[0,6] HoT B[1,6]). Including the second BSR's care of address in the returned message permits route optimization by informing the first BSR of the care of address of the second BSR. The home agent may then relay the message, e.g. the HoT message, to the first BSR as indicated by the arrow 240. In contrast to the conventional proxy Mobile IPv6 standard, the techniques described herein only require a single route optimization procedure to find the CoA of the second terminal. The standard route optimization procedure requires two round trips to establish route optimization through the mobile terminal's respective CoAs, which in a mobile environment may prove to be a critical delay.

The second phase of the route optimization procedure may include the exchange of messages by the first and second BSRs along a communication path that does not include the home agent. For example, the second phase may include the exchange of a Care-of Test Init (CoTi) and Care-of Test (CoT) messages between the first and second BSRs as indicated by the arrows 245, 250, respectively. The care of test initializing message may include information indicative of the proxy address associated with the first BSR. The care of test initializing message and the care of test message are different than the HoTi/HoT procedure at least in part because these messages are sent directly between the first and second BSRs without involving the home agent. Accordingly, these messages may be written as (B[0,6] B[1,6] CoTi) and (B[1,6] B[0,6] CoT), respectively. In one embodiment, the first and second BSRs may also exchange binding update and binding acknowledgment messages to confirm the association of the first and second BSRs, as indicated by the arrows 255, 260, respectively. Specific formats for the binding update and binding acknowledgment messages, as well as the information included in these messages, are known to persons of ordinary skill in the art.

The first and second BSRs may now act as proxies for the associated first and second access terminals and may transmit data along a data path that does not include the home agent. In the illustrated embodiment, the first access terminal may transmit a message (as indicated by the arrow 265) to the first BSR, which may then transmit the message directly to the second BSR, as indicated by the arrow 270. For example, when sending message (M[0,6] M[1,6]), the first BSR may rewrite the message to (M[0,6] B[1,6] (M[1,6])). The message may then be forwarded to the second access terminal by translating the appropriate proxy address, as indicated by the arrow 275. In the illustrated embodiment, the second access terminal may transmit a message (as indicated by the arrow 280) to the second BSR, which may then transmit the message directly to the first BSR, as indicated by the arrow 285. The message may then be forwarded to the first access terminal by translating the appropriate proxy address, as indicated by the arrow 290.

Although the method 200 is discussed in terms of IPv6 messages, the present invention is not limited to this protocol. In alternative embodiments, the method 200 may be used for route optimization with IPv4 clients on a MoIPv6 backhaul. In one embodiment, implementing route optimization for IPv4 clients may include modifying the HoTi/Hot and CoTi/CoT messages to contain the IPv4 addresses of the first and second access terminals. Once route optimization has been established, data may be tunneled by way of some form of IP-in-IP tunnel between the first and second BSR.

One or more embodiments of the route optimization techniques described above may have a number of advantages over conventional practice. Route optimization may lead to significant backhaul gains (e.g., smaller home agents, lower capacity backhaul links, and the like) since voice calls do not have to be routed through a central home agent for delivery. The back holdings may be particularly significant because most mobile-to-mobile and/or mobile-to-landline telephone calls are local. However, conventional proxy MoIPv6 does not enable any kind of route optimization when both endpoints are proxy MoIPv6 endpoints and are away from home. Thus, conventional proxy Mobile IPv6 standard may not employ route optimization in as many contexts and therefore may not achieve backhaul gains that are as large as can be achieved by the techniques described above.

Furthermore, conventional MoIPv6 only enables route optimization when one of the parties is directly reachable by its IPv6 address. Consequently, it may be possible to determine location information associated with parties using the available IPv6 address. Utilizing the proxy techniques described above may reduce or prevent leakage of the location information. Secondly, embodiments of the techniques described above provide support for IPv4 clients. Accordingly, if a provider wants to upgrade their backhaul network to MoIPv6, they do not need to replace access terminals and/or BSRs that are only capable of performing IPv4.

In one embodiment, traffic may be routed between end-points through designated proxies. Thus, a home agent may control route-optimized data paths through the wireless provider's wireless core network. The home agent controls such data paths by assigning proxy functionality to particular trusted nodes in the wireless core infrastructure. By way of route optimization, these nodes automatically become part of the data path between the network endpoints. Without limiting its applicability, an example of this is to designate border network elements to act as a proxy to hide the CoAs of the BSRs, RNCs, PDSNs, or GGSNs/SGSNs inside the wireless provider's network. Thus, if an access terminal of a first service provider exchanges messages with an access terminal of a second service provider, CoA address leakage from the first service provider to the second service provider (and vice versa) may be prevented by using the designated proxies.

For example, in the event route optimization takes place, the first service provider's home agent can direct a HoTi message to a proxy network element that connects to the second service provider's network. In this embodiment, the tunnel between home agent and the designated border proxy is a pre-established or demand-created MoIPv6 tunnel. The proxy network element may then shield the CoA of the first service provider from the second service provider. Similarly, the second service provider can use its proxy to avoid leaking CoA information to the first service provider. The described route optimization algorithm may, in some embodiments, be executed between the two border proxies for optimizing the paths between the two border proxies. Thus, the proposed mechanism can be used to direct route optimized data paths to use particular paths and network elements. These network elements can then enforce traffic policies on the route optimized traffic, e.g. traffic grooming, accounting, border gateway functionality, and the like.

As an example of an embodiment that optimizes the paths between the two border proxies, consider the case of two service providers A and B that implement two home agents HA(a) and HA(b), two BSRs BSR(a) and BSR(b), two border gateways BG(a) and BG(b), and two terminals M(a) and M(b), respectively. In the illustrated embodiment, the border gateways BG(a) and BG(b) act as proxies. When M(a) sends a message destined for M(b), HA(a) initiates route optimization between M(a) and BG(a) by directing the message and a HoTi(a) message to BG(a), as discussed above. On receipt of the message, BG(a) then forwards the message to HA(b), which then forwards the message to BG(b). By way of route optimization BG(a), HA(b), and BG(b) optimize the route between BG(a) and BG(b) through embodiments of the route optimization method described above. On receipt of the message in BG(b), BG(b) retransmits the message to HA(b) for delivery to BSR(b). This transmission triggers a route optimization between BG(b), HA(b), and BSR(b). Finally, the BSR(b) reconstructs the message and delivers the packets including the message to M(b). Alternatively, HA(b) may directly deliver the message to BSR(b) without triggering the route optimization between BG(a) and BG(b) and rely on the return message from M(b) to M(a) to establish an optimized route between BG(a) and BG(b).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
providing information indicative of a first proxy address based on a first address associated with a first access terminal;
obtaining information indicative of a second proxy address associated with a second access terminal; and
establishing a communication link between the first access terminal and the second access terminal based on the first and second proxy addresses such that the communication link does not include a home agent.

2. The method of claim 1, comprising providing a home test initializing message.

3. The method of claim 2, wherein providing the home test initializing message comprises tunneling the home test initializing message for delivery to the home agent.

4. The method of claim 2, wherein obtaining the information indicative of the second proxy address comprises receiving a home test message comprising the information indicative of the second proxy address in response to providing the home test initializing message.

5. The method of claim 1, wherein receiving the information indicative of the second proxy address comprises receiving the information indicative of the second proxy address that is formed based on a second address associated with the second access terminal.

6. The method of claim 1, wherein receiving the information indicative of the second proxy address comprises receiving a care of address associated with the second access terminal.

7. The method of claim 1, comprising providing a care of test initializing message.

8. The method of claim 7, wherein providing the care of test initializing message comprises providing a care of test initializing message including information indicative of the first proxy address associated with the first access terminal.

9. The method of claim 8, comprising receiving a care of test message.

10. The method of claim 9, wherein receiving the care of test message comprises receiving the care of test message in response to providing the care of test initializing message.

11. The method of claim 10, comprising providing a binding update message in response to receiving the care of test message and receiving a binding acknowledgment message in response to providing the binding update message.

12. The method of claim 1, wherein obtaining the information indicative of the second proxy address comprises obtaining information indicative of a second proxy address associated with a proxy element designated by the home agent.

13. The method of claim 12, wherein obtaining the information indicative of the second proxy address comprises receiving the information indicative of the second proxy address in response to the home agent providing a message to the proxy element via a pre-established or a demand-created tunnel.

14. The method of claim 1, wherein providing the information indicative of the first proxy address comprises providing information indicative of a first proxy address associated with a first service provider.

15. The method of claim 14, wherein obtaining information indicative of the second proxy address comprises obtaining information indicative of a second proxy address associated with a second service provider.
